(19) United States
(12) Patent Application Publication
(10) Pub. No.: US 2005/0028786 A1
(43) Pub. Date: Feb. 10, 2005

(54) Ionization detection system architecture to minimize PCM pin count

(76) Inventor: Guoming G. Zhu, Novi, MI (US)

Correspondence Address: Douglas A. Mullen;Dickinson Wright PLLC, Suite 800, 1901 L Street N.W., Washington, DC, 20036, US

(21) Appl. No.: 10/634,724

(22) Filed: Aug. 5, 2003

(51) Int. Cl. G01L 23/08; F02P 5/145

(52) U.S. Cl. 123/406.26; 73/35.08

(57) ABSTRACT

In the present invention, the ionization signals from a plurality of cylinders are multiplexed together to reduce the powertrain control module pin count. For an inline internal combustion engine, the total pin count is reduced from the total number of cylinders in the engine, up to five, to one. In a preferred embodiment, the method of multiplexing ionization signals from a plurality of cylinders, consists of calculating an action period, combining the ionization signals, whereby information from said ionization signals is spaced apart by at least an action period in duration, and outputting the ionization signals, whereby no overlap of information occurs between the ionization signals.

### BACKGROUND OF THE INVENTION

1. Technical Field

This invention is related to the field of internal combustion (IC) engine ignition systems. More particularly, it is related to the field of detecting an ionization signal in the combustion chamber of an IC engine and feeding the ionization signal back to the powertrain control module.

2. Discussion

In a Spark Ignition (SI) engine, the spark plug is already inside of the combustion chamber, and can be used as a detection device without requiring the intrusion of a separate sensor. During combustion, a lot of ions are produced in the plasma. H₃O⁺, C₃H₃⁺, and CHO⁺ are produced by the chemical reactions at the flame front and have sufficiently long exciting times to allow detection of these ions. If a bias voltage is applied across the spark plug gap, these free ions are attracted and will create a current.

A spark plug ionization signal measures the local conductivity at the spark plug gap when combustion occurs in the cylinder. The changes of the ionization signal versus crank angle can be related to different stages of a combustion process. The ionization current typically has three phases: the ignition or spark phase, the flame front phase, and the post-flame phase. The ignition phase is where the ignition coil is charged and later ignites the air/fuel mixture. The flame front phase is where the flame (flame front movement during the flame kernel formation) develops in the cylinder and consists, under ideal circumstances, of a single peak. The current in the flame front phase has been shown to be strongly related to the air/fuel ratio. The post-flame phase depends on the temperature and pressure development in the cylinder and generates a current whose peak is well correlated to the location of the peak pressure.

The vast majority of modem automobile engines use a four stroke or cycle operation (see FIG. 1). However, a cylinder naturally has only two strokes. To create four strokes, intake, compression, ignition, and exhaust, valves are used that control the air entering and leaving the cylinder. (See FIG. 2). As the piston starts down on the intake stroke, the intake valve opens and the air/fuel mixture is drawn into the cylinder. When the piston reaches the bottom of the intake stroke, the intake valve closes, trapping the air/fuel mixture in the cylinder.

In the compression stroke the piston moves up and compresses the trapped air/fuel mixture that was brought in by the intake stroke. In either the intake or the power stroke, the spark plug fires, igniting the compressed air/fuel mixture that produces a powerful expansion of the vapor. In the power stroke the combustion process pushes the piston down the cylinder with a great enough force to turn the crankshaft to provide the power to propel the vehicle. In the exhaust stroke, with the piston at the bottom of the cylinder, the exhaust valve opens to allow the burned exhaust gas to be expelled to the exhaust system.

Each piston fires at a different time, determined by the engine firing order. By the time the crankshaft completes two revolutions, which equals 720 crank angles for a four stroke engine, each cylinder in the engine will have gone through one power stroke. FIG. 3 illustrates firing vs. crankshaft angle for a four cylinder engine with firing order one, three, four, two. As seen from FIG. 3, it takes 720 crank degrees for a cylinder to cycle through all four strokes.

In the prior art, the number of pins required to feed the charge and ionization current signal from each cylinder in an engine back to the powertrain control module equals the number of cylinders in the engine. Thus, as the number of cylinders in the engine increases, so does the pin count. A method is needed to reduce the powertrain control module pin count.

### SUMMARY OF THE INVENTION

In view of the above, the described features of the present invention generally relate to one or more improved systems, methods and/or apparatuses for detecting and/or using an ionization current in the combustion chamber of an internal combustion engine.

In one embodiment, the present invention is a method of multiplexing ionization signals from a plurality of cylinders, comprising the steps of calculating an action period, combining the ionization signals, whereby information from the ionization signals is spaced apart by at least an action period in duration, and outputting the ionization signals, whereby no overlap of information occurs between said ionization signals.

In another preferred embodiment, the action period is calculated by dividing a number of crank degrees for a cylinder to cycle through all strokes by a total number of said plurality of cylinders.

In a further preferred embodiment, the step of outputting the ionization signals comprises multiplexing the ionization signals at intervals equal in duration to the action period.

In another preferred embodiment, the present invention is an engine comprising a plurality of cylinders, a plurality of ignition systems, whereby each of said plurality of ignition systems has an ionization signal output and is operably connected to at least one of the plurality of cylinders and wherein all ionization signal outputs are current sources, a summer having a plurality of inputs and an output, wherein at least one of the ionization signal outputs is operably connected to one of the plurality of inputs of the summer, and a powertrain control module having at least one input operably connected to the output of the summer.

In a further preferred embodiment, all of the ionization signal outputs are current sources.

In another preferred embodiment, the powertrain control module comprises a controller, memory operably connected to the controller, and software which is stored in the memory.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates the four stroke cycle operation of the modern automobile engine;

FIG. 2 illustrates the four stroke overlap on the engine crankshaft;

FIG. 3 illustrates stroke vs. crank angle (in degrees) for a four-cylinder engine's operating cycle;

FIG. 4 is a diagram of an integrated coil driver and ionization detection sub-system;

FIG. 5a illustrates the charge command V_{IN} signal;

FIG. 5b illustrates the detected ionization voltage and charge current;

FIG. 5c illustrates the ionization voltage multiplexed with the charge current feedback signal;

FIG. 6 shows a diagram of an integrated coil driver and ionization detection sub-system;

FIG. 7 shows a block diagram of the ionization detection system

FIG. 8 illustrates an ignition control system using an integrated coil;

FIG. 9 is a graph of an ionization signal;

FIG. 10a is a plot of the ionization signal for cylinder 90;

FIG. 10b is a plot of the ionization signal for cylinder 91;

FIG. 10c is a plot of the ionization signal for cylinder 92;

FIG. 10d shows the multiplexed ionization signal for cylinders 90, 91 and 92;

FIG. 11 is a drawing of the multiplexed ignition control system of the present invention;

FIG. 12 is a schematic of a current source which uses a bipolar junction transistor;

FIG. 13 a logic block diagram of the multiplexing circuit used to multiplex the charge and ionization currents from the four cylinders in the engine;

FIG. 14 is a flowchart of the steps taken when multiplexing the charge current and ionization signals from each cylinder;

FIG. 15 is a logic block diagram in which a summer is used to combine the charge and ionization signals;

FIG. 16 is a logic block diagram of the multiplexing circuit of the present invention.

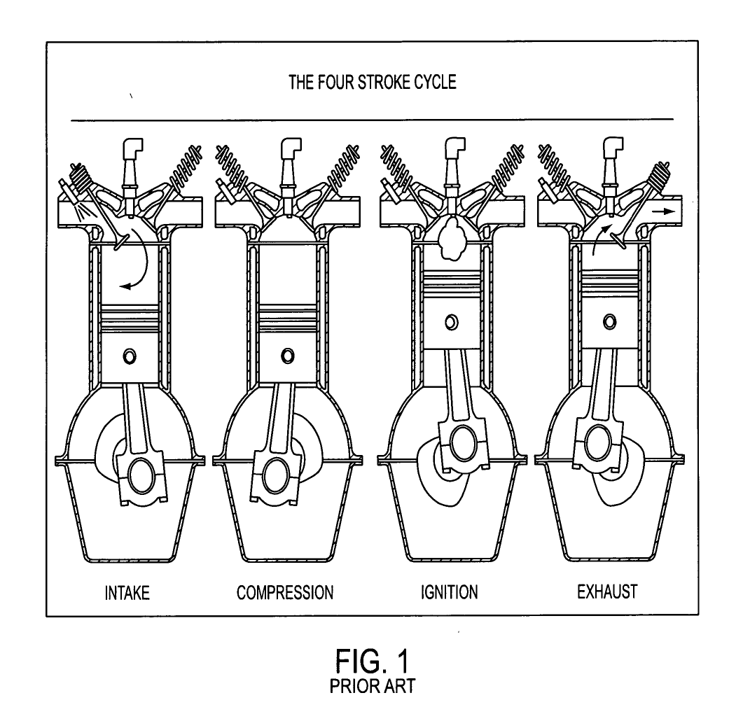

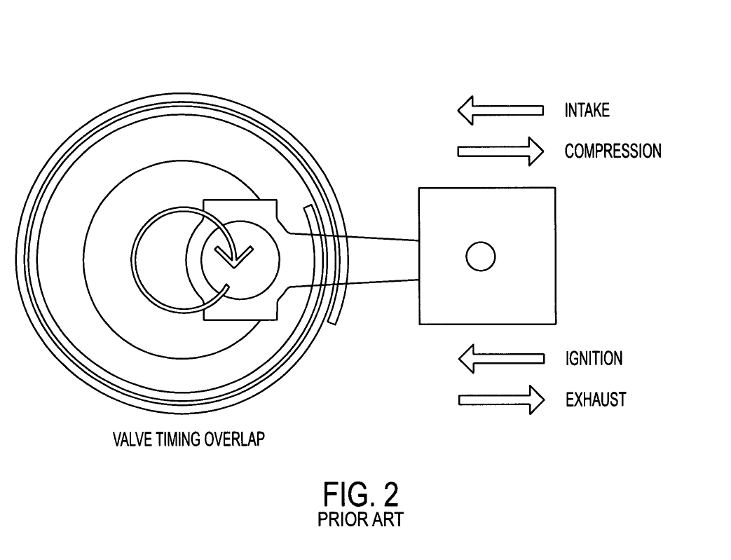

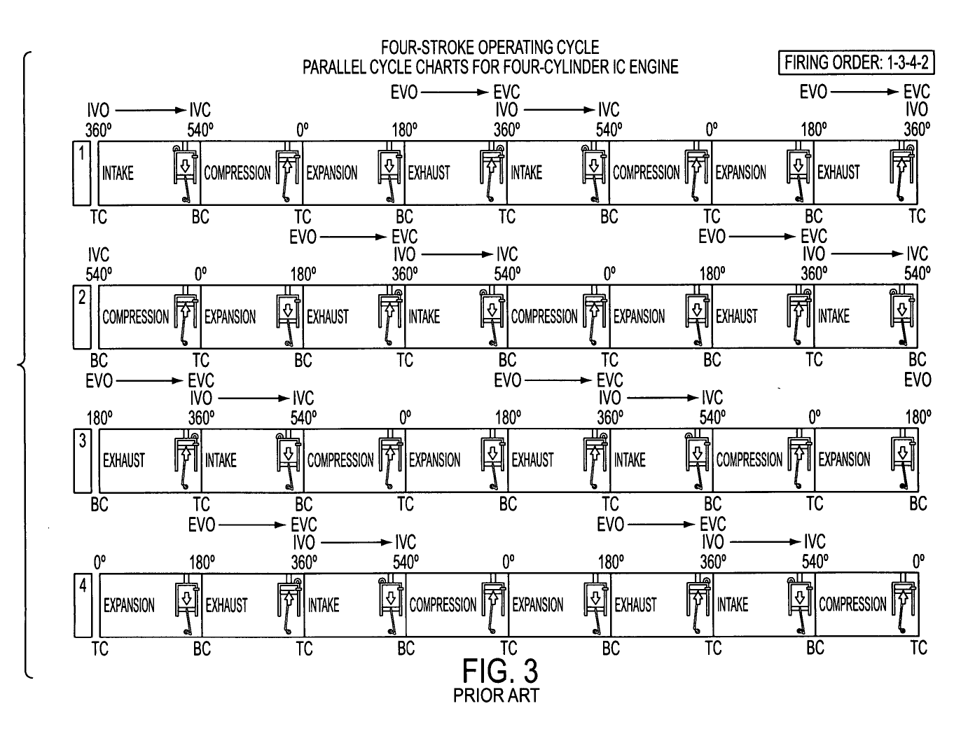

### DETAILED DESCRIPTION OF THE PREFERRED EMBODIMENT

The combustion process of a spark ignited (SI) engine is governed by the in-cylinder air/fuel (A/F) ratio, temperature and pressure, the exhaust gas recirculation (EGR) rate, the ignition time, duration, etc. Engine emission and fuel economy are tightly dependent on its combustion process. For homogenous combustion engines, most often, the engine A/F ratio is controlled in a closed loop using a heated exhaust gas oxygen (HEGO) or universal exhaust gas oxygen (UEGO) sensor. The exhaust gas recirculation EGR rate is controlled with the help of Δ pressure measurement. Due to unavailability of a low cost combustion monitor sensor, engine spark timing is controlled in an open loop and corrected by a knock detection result. One of the low cost options for combustion sensing is ionization detection, which measures ion current generated during the combustion process by applying a bias voltage onto a spark plug gap.

When moving the ignition driver on to the ignition coil (e.g., pencil and on-plug coils), it would be desirable to integrate both the ignition driver circuit and ionization detection circuit onto the ignition coil. One open issue is to use minimum pin count of the integrated package to cover both integrated driver and ionization detection circuits for reduced cost. One feature of the present invention multiplexes the ignition coil charge current feedback signal with the ionization signal, and therefore, reduces the package pin count by one.

The conventional design for an integrated ignition coil with driver and ionization detection circuit consists of five pins: coil charge gate signal, charge current feedback signal, ionization current signal, battery power and ground. Each pin count increases the ignition subsystem cost due to the ignition coil connector, the harness, and the engine control unit (ECU) connector. One method to reduce subsystem cost is to multiplex both the primary charge current feedback and the ionization current signals. This method is disclosed in copending U.S. application Ser. No. 10/458,627, “A Method For Reducing Pin Count Of An Integrated Ignition Coil With Driver And Ionization Detection Circuit By Multiplexing Ionization And Coil Charge Current Feedback Signals.” The primary charge current feedback and the ionization current signals can be multiplexed because the primary coil charge and combustion events occur sequentially.

It is desirable to integrate the ignition coil driver electronics onto the ignition coil (e.g., pencil or coil-on-plug) to get rid of high current pins between powertrain control module PCM and ignition coils and to reduce electrical and magnetic interference. A design for an integrated ignition coil with driver consists of four pins: Ignition coil primary winding charge gate signal; Primary winding charge current feedback signal; Battery power supply B+; and Battery ground. The current feedback pin multiplexes both the ionization and driver current feedback signals into one signal.

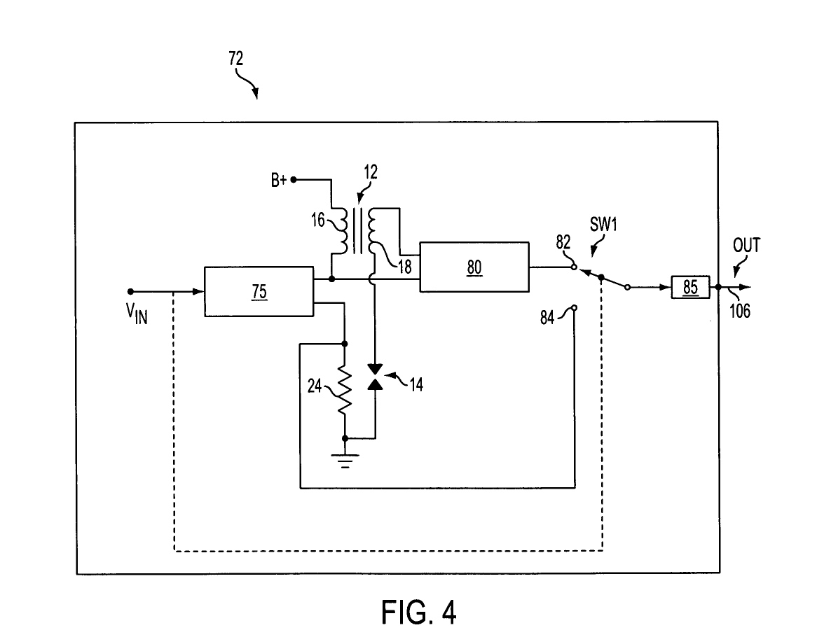

FIG. 4 shows a diagram of an integrated coil driver and ionization detection sub-system 72 which illustrates multiplexing the ionization signal and the charge current or driver current feedback signals. The sub-system consists of a coil driver circuit 75, an ionization detection circuit 80, and an amplifier 85. The driver circuit 75 charges the primary winding 16 of the ignition coil 12 when the charge is enabled. Next, the ionization detection circuit 80 applies a bias voltage through the secondary winding 18 of the ignition coil 12 to the spark plug 14 and the resulting ionization current Iᵢₒₙ is caused by the ions produced during the combustion process. The amplifier 85 magnifies the detected signal for improved signal to noise ratio.

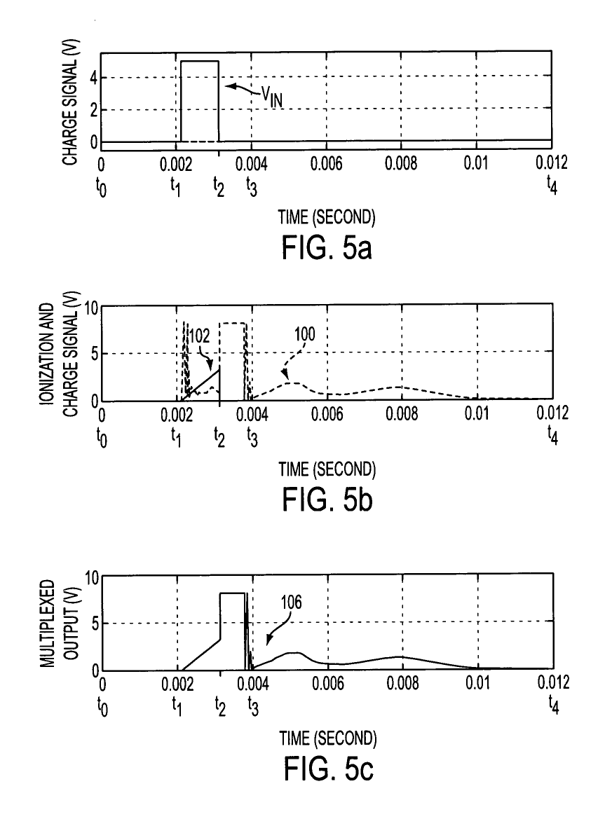

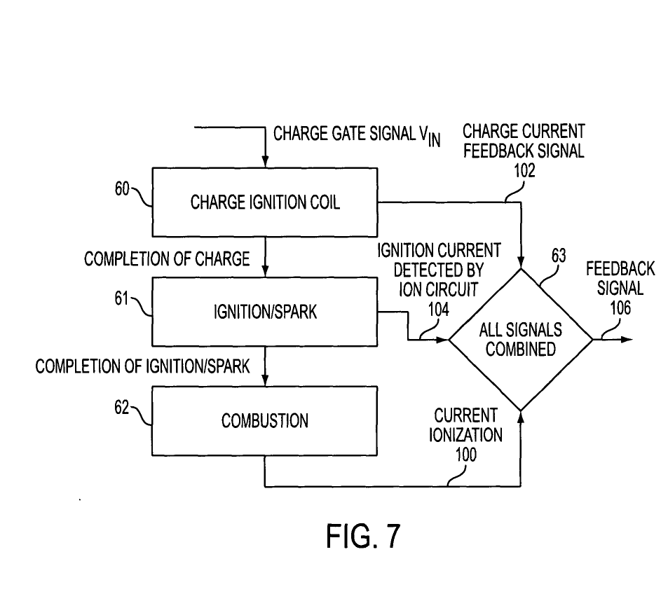

FIG. 5a-c shows the charge command Vᵢₙ signal (FIG. 5a), the detected ionization voltage or signal 100, represented by a dashed line, the charge current feedback signal 102, represented by a solid line (FIG. 5b), and the ionization voltage or signal multiplexed with the charge current feedback signal 106 (FIG. 5c). Between t₀ and t₁ there is no combustion and the ignition coil 12 is at rest. The charge command V_{IN} becomes enabled at t₁ and disabled at t₂. During this period, the primary coil 16 is fully charged (60), see FIG. 7. This is a detection window for current feedback. The ignition of the air/fuel mixture occurs between time t₂ and time t₃ (61). The combustion process is completed between time t₃ and time t₄ (62).

The multiplexed signal 106 first outputs the ionization detection signal 100 and replaces the ionization signal 100 with the charge current feedback signal 102 when the charge command Vᵢₙ is enabled, see FIG. 5a. FIG. 5b shows both charge current feedback 102 (solid) and ionization 100 (dash) signals. FIG. 5c shows the multiplexed signal 106.

During time t₀ and time t₁, the output is ionization signal 100. The switch SW1 is connected to the output of the ionization detection circuit (or the ion current node) 82. When the charge command V_{IN} is enabled between t₁ and t₂, the switch SW1 switches to the charge current feedback signal node 84 which is connected thru driver circuit 75 to one end of the primary winding 16 of the ignition coil 12. Thus, the switch SW1 outputs the charge current feedback signal 102 (a voltage signal across resistor 24 that is proportional to primary charge current, see FIG. 4). After t₂, the signal 106 switches back to ionization signal 100. Note that between t₂ and t₃, the ionization signal 100 provides information regarding the ignition process 104 (61), i.e., the saturated ignition current detected by the ion circuit, and between t₃ and t₄ information regarding the combustion process (62).

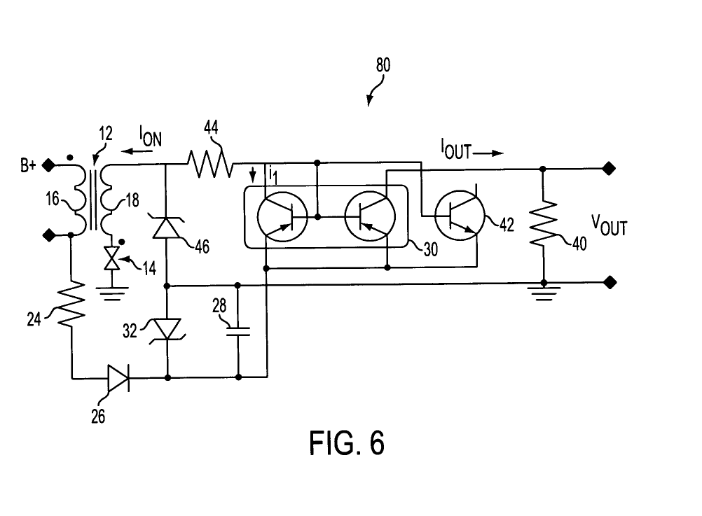

FIG. 6 shows a diagram of an integrated coil driver and ionization detection sub-system 80. The sub-system consists of ignition coil 12 and an ionization detection circuit 28, 30. A driver circuit charges the primary winding 16 of the ignition coil 12 when the charge is enabled by charge command V_{IN}. Next, the ionization detection circuit 28, 30 applies a bias voltage through the secondary winding 18 of the ignition coil 12 to the spark plug 14. Ionization current is generated due to the ions produced during the combustion process. An amplifier is used to magnify the detected signal for improved signal to noise ratio. It is noted that the charge current feedback signal 102 is a current source.

In summary, the multiplexed feedback signal 106 outputs the ionization feedback signal 100 and switches to charge current feedback signal 102 when the charge command V_{IN} is active. FIG. 7 is a flowchart illustrating the steps of the present embodiment of the integrated coil driver and ionization detection sub-system 72.

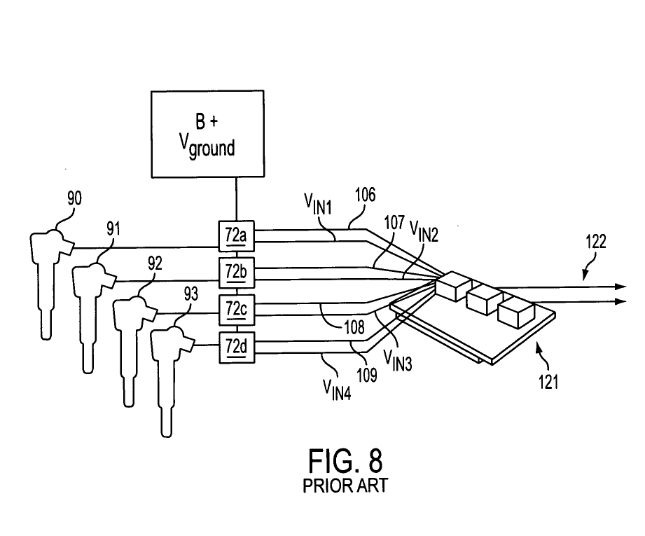

As stated supra, for each cylinder in an internal combustion (IC) engine 161, an ignition coil integrated with a driver and an ionization detection circuit 72 consists of four pins: Ignition control, Charge and ionization current feedback signal, Battery power supply B+; and Battery ground. The number of pins required to feed the charge and ionization current signal 106 from each cylinder 90-93 in the engine 161 back to the powertrain control module PCM 121 equals the number of cylinders 90-93 of the IC engine 161. Thus, as the number of cylinders 90-93 in the engine 161 increases, so does the pin count. A typical ignition control system using an ignition coil with integrated driver and ionization detection is shown in FIG. 8 which illustrates the charge and ionization current feedback signals 106-109, the charge command signals V_{IN1}-V_{IN4} (one for each cylinder), the integrated driver and ionization detection circuit 72a-72b (one for each cylinder), the powertrain control module 121 and other sensor and control signals 122.

In a preferred embodiment, the ionization signal 100 from each cylinder 90 is multiplexed together to reduce the powertrain control module PCM 121 pin count. In another preferred embodiment, the ionization signal 100 and the charge current feedback signal 102 from each cylinder 90 are multiplexed together to reduce the PCM pin count required for charge current and ionization feedback control. For an inline four-cylinder IC engine 161, the total pin count is reduced from the total number of cylinders 90-93 in the engine 161 to one. For example, for an inline IC engine up to five cylinders 90, the proposed architecture reduces the required PCM pin count from five to one, and for a “V” engine 161 up to 10 cylinders, the PCM pin count is reduced to two.

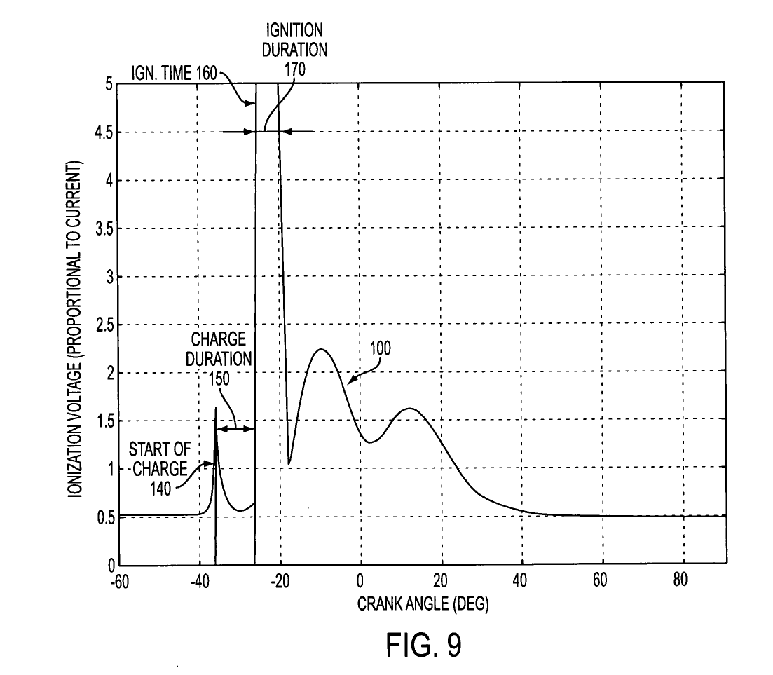

One of the reasons that all of the charge and ionization current feedback signals 106-109 from each cylinder 90-93 can be multiplexed into one pin is that the charge and ionization current feedback signal 106 becomes active only during the following periods: charging of the primary winding, ignition, and combustion. These three periods, cumulatively referred to as a cylinder's active period, covers less than 120 crank degrees (see FIG. 9). Another reason is that the feedback signal is a current source signal. Therefore, merging (or connecting) all of the charge and ionization current feedback signals 106-109 into one signal 116 adds up all of the signals.

A typical ionization signal 100 versus crank angle is shown in FIG. 9. The initial rise of the ionization signal 100 before the sharp change at the ignition time is the pre-charge (or start of charge) of the primary coil 140. After the primary coil charge is completed, the signal goes down and rises almost vertically (i.e., a step rise) versus crank angle. The breakdown has occurred at the step's rising edge. Spark timing can be detected based on this point. That is, the ignition or spark time occurs when the ionization signal has a step rise. This is the ignition or spark time 160. The time difference between the first rise and the stepped rise is the primary charge duration 150. The duration between the sharp stepped rising and the subsequent declining represents the ignition duration 170.

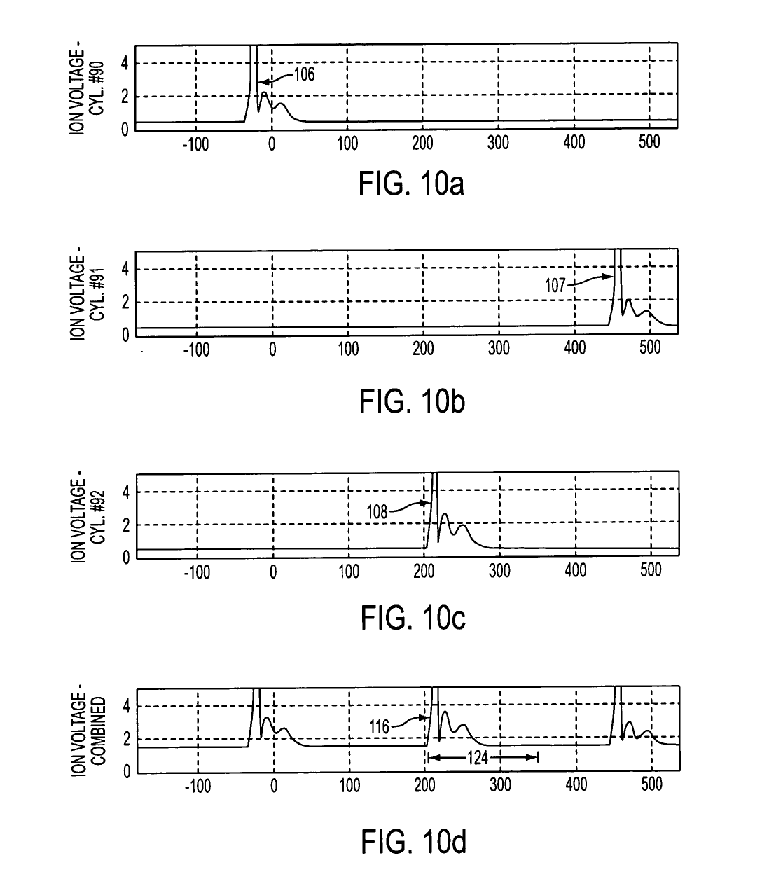

For a four cylinder 90 inline IC engine 161, assuming the combustion event is evenly distributed over 720 crank degrees, the charge and ionization current signals 106-109 from each cylinder 90-93 will not overlap for up to five cylinders (720 degrees divided by 144 degrees) if the charge and ionization current signals 106-109 (see FIGS. 10a-10c) are multiplexed into a single signal 116, see FIG. 10d which shows the ionization signals for cylinders 90, 91 and 92 plotted on one graph. Note that no overlap occurs between the three cylinders during each cylinder's active period 124.

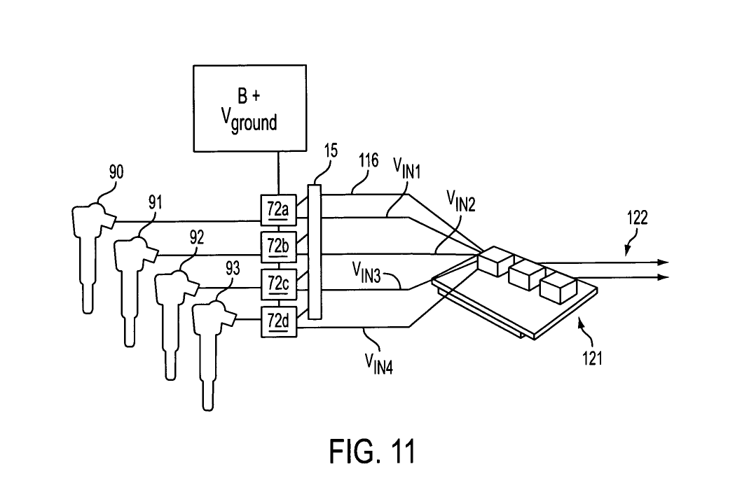

Therefore, multiplexing all of the charge and ionization current feedback signals, one from each cylinder of the engine, into one signal will not result in any loss of charge current and ionization information. See FIG. 11 for the system architecture. A powertrain control module 121 outputs ignition control signals V_{IN1}, V_{IN2}, V_{IN3} and V_{IN4} to corresponding integrated coil driver and ionization detection sub-systems 72a-d. The individual charge and ionization current feedback signals 106-109 from each integrated coil driver and ionization detection sub-systems 72a-d are multiplexed together to form a multiplexed charge and ionization current feedback signal 116.

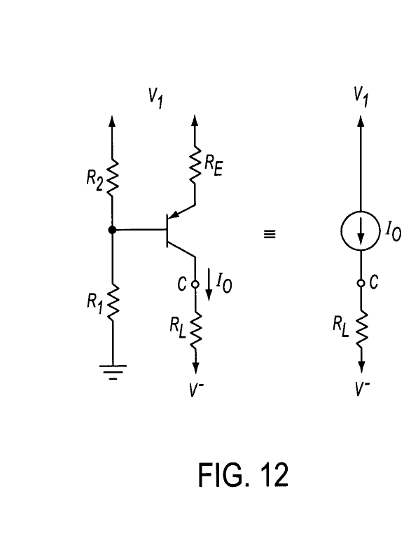

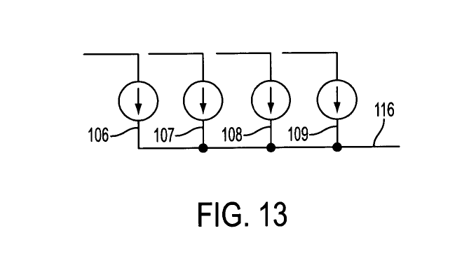

The charge and ionization current feedback output signal 106 from each cylinder is a current source. See FIG. 12 which is a schematic of a current source which uses a bipolar junction transistor as the transistor. Since a current source provides a desired current into a load, connecting the individual charge and ionization current feedback signals 106-109 from each cylinder 90-93 together (see FIG. 13) adds up the signals and won't degrade the signal quality of any of the individual charge and ionization current feedback signals 106-109. Thus, the signals from up to five cylinders in an engine can be combined into one multiplexed charge and ionization current feedback signal 116 which contains charge and ionization information for all five cylinders without overlap. For a “V” engine with two banks of five cylinders each, each bank of the “V” engine can be multiplexed. Therefore, only two signals are fed into the powertrain control module PCM 121.

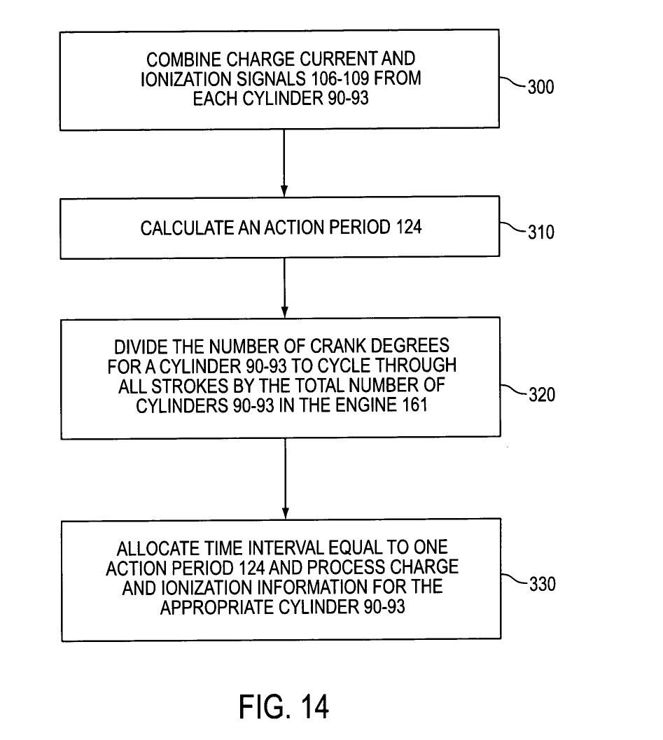

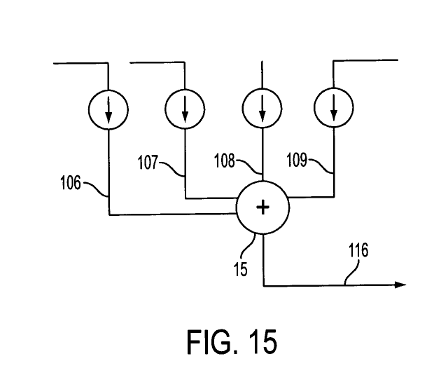

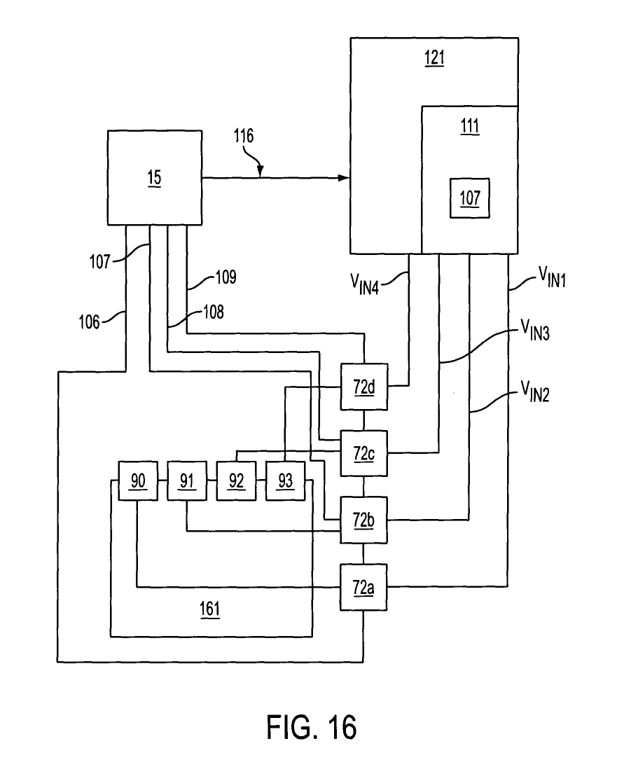

The following steps are taken when multiplexing the charge current and ionization signals 106-109 from each cylinder 90-93, see FIG. 14. First, the charge current and ionization signals 106-109 from each cylinder 90-93 are combined (300). Since there is no overlap, a simple summer 15 can be used to combine the signals (FIG. 15). This summer can be implemented by connecting all charge and ionization signal together since all signals are current sources.

Next, the powertrain control module PCM 121 calculates an action period 124 sufficiently long in duration to prevent loss of charge current and ionization information from any cylinder and short enough to prevent overlap between the charge current and ionization signals 106-109 from each cylinder 90-93 (310).

In a preferred embodiment, the step of calculating an action period 124 comprises dividing the number of crank degrees for a cylinder 90-93 to cycle through all strokes by the total number of cylinders 90-93 in the engine (320). In a preferred embodiment, an action period 124 of 144 crank degrees is used for a five-cylinder bank, where it takes 720 cranks degrees for a cylinder to cycle through all strokes.

After all the charge and ionization signals 106-109 are multiplexed, each cylinder 90-93 of the engine 161 is allocated a time interval equal to one action period 124 from the multiplexed charge and ionization current feedback signal 116. The powertrain control module 121 processes charge and ionization information for the appropriate cylinder 90-93 over that time interval (330). As discussed above, for a five-cylinder engine the output of the combiner 15 is processed every 144 degrees.

In a preferred embodiment, the steps (or instructions) in FIG. 14 are stored in software or firmware 107 located in memory 111, see FIG. 17. The steps are executed by a controller 121. The memory 111 can be located on the controller 121 or separate from the controller 121. The memory 111 can be RAM, ROM or one of many other forms of memory apparatuses. The controller 121 can be a processor, a microprocessor or one of many other forms of digital or analog processing apparatuses. In a preferred embodiment, the controller is the powertrain control module PCM 121.

While the invention has been disclosed in this patent application by reference to the details of preferred embodiments of the invention, it is to be understood that the disclosure is intended in an illustrative rather than in a limiting sense, as it is contemplated that modification will readily occur to those skilled in the art, within the spirit of the invention and the scope of the appended claims and their equivalents.

1. A method of multiplexing ionization signals from a plurality of cylinders, comprising the steps of:
calculating an action period;
combining said ionization signals, whereby information from said ionization signals is spaced apart by at least an action period in duration; and
outputting said ionization signals, whereby no overlap of information occurs between said ionization signals.

2. The method according to claim 1 wherein said action period is calculated by dividing a number of crank degrees for a cylinder to cycle through all strokes by a total number of the plurality of cylinders.

3. The method according to claim 1 wherein said step of outputting said ionization signals comprises multiplexing said ionization signals at intervals equal in duration to said action period.

4. The method according to claim 1 wherein said step of combining said ionization signals comprises summing said ionization signals.

5. The method according to claim 1 further comprising the step of multiplexing each of said ionization signals with a driver current feedback signal.

6. The method according to claim 2 wherein said number of crank degrees for a cylinder to cycle through all strokes is 720 degrees and said total number of said plurality of cylinders is five.

7. The method according to claim 5 wherein said step of multiplexing each of said ionization signals with a driver current feedback signal comprises the steps of:
outputting said ionization signal;
enabling a charge command signal, whereby a primary winding of an ignition coil is charged;
outputting a charge current feedback signal while said charge command is enabled;
disabling said charge command signal; and
outputting said ionization signal after said charge command signal is disabled.

8. An engine, comprising:
a plurality of cylinders;
a plurality of ignition systems, whereby each of said plurality of ignition systems has an ionization signal output and is operably connected to at least one of said plurality of cylinders;
a summer having a plurality of inputs and an output, wherein at least one of said ionization signal outputs is operably connected to one of said plurality of inputs of said multiplexer; and
a powertrain control module having at least one input operably connected to said output of said summer.

9. The engine according to claim 8 wherein all of said ionization signal outputs are current sources.

10. The engine according to claim 8 wherein at least one of said plurality of ignition systems is an integrated ignition system.

11. The engine according to claim 8 wherein said powertrain control module comprises:
a controller;
memory operably connected to said controller; and
software stored in said memory.

12. The engine according to claim 10 wherein said integrated ignition system comprises:
an ignition coil comprising a primary winding with a first and a second end and a secondary winding with a first and a second end;
a coil driver circuit having a first end operably connected to said second end of said primary winding;
an ionization detection circuit having at least two inputs and an output, wherein a first input is operably connected to said second end of said primary winding, and a second input is operably connected to said first end of said secondary winding; and
a switch having at least two inputs and an output, wherein a first input is operably connected to said output of said ionization detection circuit, a second input is operably connected to a second end of said coil driver circuit, whereby said output of said switch is multiplexed between an ionization signal and a charge current feedback signal.

13. The engine according to claim 11 wherein said software comprises:
instructions to calculate an action period, whereby no overlap occurs between ionization signals; and
instructions to sample at least one of said ionization signals over said action period.

14. The engine according to claim 13, wherein said software further comprises instructions to calculate said action period by dividing a number of crank degrees for a cylinder to cycle through all strokes by a total number of said plurality of cylinders.

15. The integrated ignition system according to claim 12 further comprising an amplifier having an input and an output, wherein said input is operably connected to said output of said switch.

16. The engine according to claim 12 wherein all of said ionization signal outputs are current sources.

17. An engine, comprising:
a plurality of cylinders;
a plurality of ignition systems, whereby each of said plurality of ignition systems has an ionization signal output and is operably connected to at least one of said plurality of cylinders, and wherein all of said ionization signal outputs are current sources and at least one of said plurality of ignition systems is an integrated ignition system;
a summer having a plurality of inputs and an output, whereby at least one of said ionization signal outputs is operably connected to one of said plurality of inputs of said summer; and
a powertrain control module having at least one input operably connected to said output of said summer, wherein said powertrain control module comprises
a controller,
memory operably connected to said controller, and
software stored in said memory.

18. The engine according to claim 17 wherein said software comprises:
instructions to calculate an action period, whereby no overlap occurs between ionization signals; and
instructions to sample a multiplexed ionization signal.

19. The engine according to claim 17 wherein said integrated ignition system comprises:
an ignition coil comprising a primary winding with a first and a second end and a secondary winding with a first and a second end;
a coil driver circuit having a first end operably connected to said second end of said primary winding;
an ionization detection circuit having at least two inputs and an output, wherein a first input is operably connected to said second end of said primary winding, and a second input is operably connected to said first end of said secondary winding; and
a switch having at least two inputs and an output, wherein a first input is operably connected to said output of said ionization detection circuit, a second input is operably connected to a second end of said coil driver circuit, whereby said output of said switch is multiplexed between an ionization signal and a charge current feedback signal.

20. The engine according to claim 18, wherein said software further comprises instructions to calculate said action period by dividing a number of crank degrees for a cylinder to cycle through all strokes by a total number of said plurality of cylinders.
